(19) United States
(12) Patent Application Publication
(10) Pub. No.: US 2024/0416369 A1
(43) Pub. Date: Dec. 19, 2024

(54) AIR-ASSISTED ULTRASONIC MAGNETIZATION ELECTROSTATIC NOZZLE

(71) Applicant: JIANGSU UNIVERSITY, Zhenjiang (CN)

(72) Inventors: Jianmin GAO, Zhenjiang (CN); Wenhao DING, Zhenjiang (CN)

(73) Assignee: JIANGSU UNIVERSITY, Zhenjiang (CN)

(21) Appl. No.: 18/269,297

(22) PCT Filed: Dec. 30, 2022
(86) PCT No.: PCT/CN2022/144072

§ 371 Date: Jul. 26, 2024

(30) Foreign Application Priority Data
Dec. 23, 2021 (CN) 202111588354.9

(51) Int. Cl. B05B 5/03; A01G 31/02; B05B 5/053; B05B 5/16

(52) U.S. Cl. CPC B05B 5/03; A01G 31/02; B05B 5/0533; B05B 5/1608

(57) ABSTRACT

The present disclosure provides an air-assisted ultrasonic magnetization electrostatic nozzle, and belongs to the technical field of agricultural equipment. The air-assisted ultrasonic magnetization electrostatic nozzle includes a Laval tube, a liquid inlet section, a charging electrode plate, and a resonant cavity. After being accelerated by the Laval tube, an air impacts a liquid that enters through the liquid inlet section arranged at an outlet end of the Laval tube. The liquid is impacted into fine droplets and the fine droplets are positively electrified after passing through the charging electrode plate arranged at an outlet end of the liquid inlet section, to obtain electrified droplets. The electrified droplets enter the resonant cavity and are magnetized, to obtain magnetized droplets. The magnetized droplets are atomized and sprayed out by a metal film arranged at an outlet end of the resonant cavity. In the present disclosure, with the arrangement a metal oscillator, the Laval tube, and the charging electrode plate, the atomized droplets are magnetized and electrified, so that the atomized droplets are more effectively adsorbed on plants in an aeroponic chamber, to accelerate the root system growth of aeroponically propagated crops. With the arrangement of a temperature-regulating device, airflows with different temperatures can be output according to the temperature of the aeroponic chamber, so as to regulate the environmental temperature and promote the rapid growth of the plants.

### TECHNICAL FIELD

The present disclosure relates to the technical field of agricultural equipment, and particularly to an air-assisted ultrasonic magnetization electrostatic nozzle.

### BACKGROUND

Rapid propagation of plants is a method of obtaining a large number of regenerated plants with consistent heredity in a short time by using the plant tissue culture technology to culture explants in vitro. Conventional rapid propagation technologies have the disadvantages of long cultivation cycles, and high consumption of power, manpower, and raw materials.

Aeroponic propagation is the most advanced seedling raising method at present. Compared with conventional rapid propagation technologies, it can shorten the rooting time of most varieties by ¼ to ½ and increase the survival rate by 20% to 30%, with the surviving seedlings having complete roots, providing the advantages such as low costs, fast rooting speeds, and high survival rates.

However, aeroponic propagation has the disadvantage of high electricity consumption and poor resistance to external climate fluctuations. Once power outage occurs, great damage such as the death of seedlings due to water loss and drought will be caused. Therefore, it is necessary to speed up the process of aeroponic propagation, so that plant tissues in vitro can take roots and become seedlings more quickly, thereby reducing the overall consumption of electricity.

### SUMMARY

To overcome the drawbacks in the prior art, the present disclosure provides an air-assisted ultrasonic magnetization electrostatic nozzle. With the arrangement a metal oscillator, a Laval tube, and a charging electrode plate, the atomized droplets are magnetized and electrified, so that the atomized droplets are more effectively adsorbed on plants in an aeroponic chamber, to accelerate the root system growth of aeroponically propagated crops. With the arrangement of a temperature-regulating device, airflows with different temperatures can be output according to the temperature of the aeroponic chamber, so as to regulate the environmental temperature and promote the rapid growth of plants.

The above technical object of the present disclosure is attained with the following technical means.

The present disclosure provides an air-assisted ultrasonic magnetization electrostatic nozzle, including a Laval tube, a liquid inlet section, a charging electrode plate, and a resonant cavity.

After being accelerated by the Laval tube, an air impacts a liquid that enters through the liquid inlet section arranged at an outlet end of the Laval tube. The liquid is impacted into fine droplets, and the fine droplets are positively electrified after passing through the charging electrode plate arranged at an outlet end of the liquid inlet section, to obtain electrified droplets. The electrified droplets enter the resonant cavity and are magnetized, to obtain magnetized droplets. The magnetized droplets are atomized and sprayed out by a metal film arranged at an outlet end of the resonant cavity.

In the above solution, a metal oscillator is arranged in the resonant cavity; an excitation coil surrounds an outer side of the metal oscillator; an oscillator stopper is arranged on one side of the metal oscillator, one end of a connecting rod is arranged on the oscillator stopper, and an other end of the connecting rod is connected with the metal film; the excitation coil is connected to an amplitude-modulated high-frequency power supply, and a vibration frequency of the metal oscillator is adjustable by adjusting a current frequency of the amplitude-modulated high-frequency power supply; and the metal oscillator drives the metal film through the connecting rod to vibrate at a high frequency.

In the above solution, the resonant cavity is a gradually expanding tube along a moving direction of the electrified droplets; and the metal oscillator is supported and positioned by a high temperature resistant elastic gasket.

In the above solution, the metal film is provided with a micropore group.

In the above solution, a plurality of through holes are uniformly arranged on the charging electrode plate.

In the above solution, axial fans are respectively arranged at an inlet end and the outlet end of the Laval tube, and permanent magnet rings are arranged on an outer wall of the Laval tube and at positions corresponding to the axial fans; and one of the axial fans which is arranged at the outlet end of the Laval tube is provided at a front end of the charging electrode plate, and the droplets are first crushed by the one of the axial fans which is arranged at the outlet end of the Laval tube and then electrified by the charging electrode plate.

In the above solution, the two axial fans are connected to a current integration module respectively through lead wires to form a closed loop, the rotating axial fans cut magnetic induction lines to generate an induced current, and the current integration module rectifies and filters the induced current to supply power to the charging electrode plate, to electrify the droplets hitting the charging electrode plate.

In the above solution, the Laval tube includes a primary Laval tube and a secondary Laval tube; a Laval tube connecting section is arranged between the primary Laval tube and the secondary Laval tube, the Laval tube connecting section is provided with a through hole, one end of an airway pipe is arranged in the Laval tube connecting section, an other end of the airway pipe extends out of the Laval tube connecting section and is sealedly communicated with a temperature-regulating air guiding section, and the temperature-regulating air guiding section is configured to guide a part of an airflow from the primary Laval tube; the temperature-regulating air guiding section is a T-shaped three-way structure, and other two ends of the temperature-regulating air guiding section are respectively communicated with a temperature-regulating device housing and a cold airflow pipe; the temperature-regulating device housing is configured to raise a temperature of the airflow to obtain a high-temperature airflow and discharge the high-temperature airflow to an aeroponic chamber to raise a temperature of the aeroponic chamber; and the cold airflow pipe discharges the airflow to a plant root environment of the aeroponic chamber.

In the above solution, a temperature-regulating air inlet section and a conical resonant tube are arranged in the temperature-regulating device housing in sequence, and a hot airflow pipe is arranged at an outlet of the temperature-regulating device housing; the air enters the temperature-regulating air inlet section and the conical resonant tube through the temperature-regulating air guiding section and is heated, and is then discharged through the hot airflow pipe; and both the temperature-regulating air guiding section and the temperature-regulating air inlet section are tapered pipes along an airflow direction.

In the above solution, the hot airflow pipe and the cold airflow pipe are each provided with a solenoid valve, and on and off of the solenoid valve are controlled by a control module according to a status of the aeroponic chamber.

The present disclosure has the following advantages.

1. In the present disclosure, a function of adjusting and controlling the ambient temperature is achieved by outputting airflows with different temperatures according to the change of the ambient temperature. In addition, the atomized droplets are magnetized and electrified by the metal oscillator, the Laval tube, and the charging electrode plate. Through the magnetization of the atomized droplets by a strong magnetic field, magnetized droplets with a nanoscale particle size can be generated. The self-generating contact-charging mode is adopted to electrify the droplets, so that the droplets are more effectively adsorbed on the wound of aeroponically propagated plants, thereby speeding up the root growth of aeroponically propagated crops.

2. In the present disclosure, high-pressure air enters through an air compressor interface of a left axial flow section, and is accelerated to a supersonic speed through a primary Laval tube. At a Laval connecting section, the supersonic airflow is divided. One part of the airflow enters the temperature-regulating device through an airway pipe joint. The other part of the airflow enters a secondary Laval tube for secondary acceleration, and converges with a liquid flow in a liquid inlet section for primary atomization. The high-speed liquid flow drives a blade of a right axial fan to rotate at a high speed and cut the magnetic induction lines. An induced current generated in the metal axial fan is processed by the current integration module and then connected to the charging electrode plate through a lead wire. After the primary atomization, the droplets hit the high-speed rotating axial fan blade for secondary atomization. After the secondary atomization, the droplets hit the charging electrode plate and lose negative charge and therefore are positively electrified. The excitation coil is connected to the amplitude-modulated high-frequency power supply through a lead wire. An alternating magnetic field generated by the excitation coil interacts with the induced current generated in the metal oscillator to cause the metal oscillator to vibrate at a high frequency. After the secondary atomization, the electrified droplets enter the magnetizing resonant cavity, and hit the metal oscillator for tertiary atomization. After the electrified droplets move in a direction perpendicular to the magnetic induction lines, the metal oscillator drives the metal film through the connecting rod to vibrate at a high frequency, so that the droplets further undergo quaternary atomization and are discharged from the micropore group on the metal film, to obtain nanoscale magnetized droplets.

3. In the present disclosure, the charging electrode plate is provided with densely and uniformly distributed through holes with the same aperture, and is selective to the particle sizes of the droplets passing therethrough. In addition, the direct-contact charging mode is adopted to uniformly electrify the droplets that hit the plate surface. According to the electrostatic principle, the positively electrified droplets have increased adhesion to plants, and through the magnetization by the resonant cavity, the magnetized droplets can promote the growth of plants and improve the quality of crops.

4. In the present disclosure, after air enters the temperature-regulating device through the airway pipe, a cold or hot airflow may be output through the cold airflow pipe or the hot airflow pipe, thereby improving the stress resistance of aeroponically propagated plants to the change of ambient temperature. To be specific, a part of the airflow rises in the temperature after passing through the conical resonant tube.

5. In the present disclosure, the metal oscillator drives the metal film through the connecting rod to vibrate at a high frequency to further atomize the droplets. In addition, the high temperature resistant elastic gasket is arranged to support the metal oscillator. The high temperature resistant elastic gasket is arranged for two purposes: preventing itself from being melted by heat generated by the metal oscillator, and providing an elastic movement area for the metal oscillator to drive the connecting rod.

6. In the present disclosure, the axial fan arranged at the inlet end of the Laval tube in the present disclosure can assist in air intake and serves as a power supply, and the axial fan at the outlet end of the Laval tube can be used to break up the droplets and also serves as a power supply to electrify the charging electrode plate.

### BRIEF DESCRIPTION OF THE DRAWINGS

FIG. 1 is a schematic cross-sectional view of an air-assisted ultrasonic magnetization electrostatic nozzle according to an embodiment of the present disclosure.

FIG. 2 is a schematic axonometric view of FIG. 1.

FIG. 3 is a schematic cross-sectional view of a temperature-regulating device in FIG. 1.

FIG. 4 is a schematic view of a magnetization and liquid discharge part in FIG. 1.

FIG. 5 is a partially enlarged schematic view of part A in FIG. 1.

FIG. 6 is a partially enlarged schematic view of part B in FIG. 1.

FIG. 7 is a schematic structural view of a left axial flow section in FIG. 1.

FIG. 8 is a schematic structural view of a liquid inlet section in FIG. 1.

FIG. 9 is a schematic structural view of a metal oscillator in FIG. 1.

FIG. 10 is a schematic structural view of a charging electrode plate in FIG. 1.

FIG. 11 is a schematic view illustrating liquid discharging from a metal film in FIG. 1.

FIG. 12 is an electromagnetic thermal effect diagram of a metal oscillator made of a copper material according to an embodiment of the present disclosure.

FIG. 13 is an electromagnetic thermal effect diagram of a metal oscillator made of a structural steel material according to an embodiment of the present disclosure.

FIG. 14 is an electromagnetic thermal effect diagram of a metal oscillator made of an aluminum alloy material according to an embodiment of the present disclosure.

FIG. 15 is a diagram illustrating a heating effect of a temperature-regulating device according to an embodiment of the present disclosure.

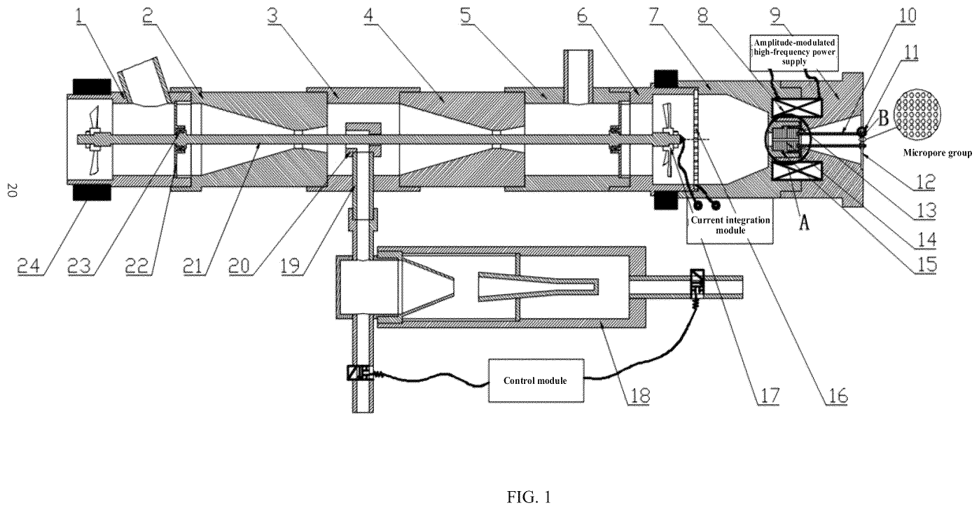

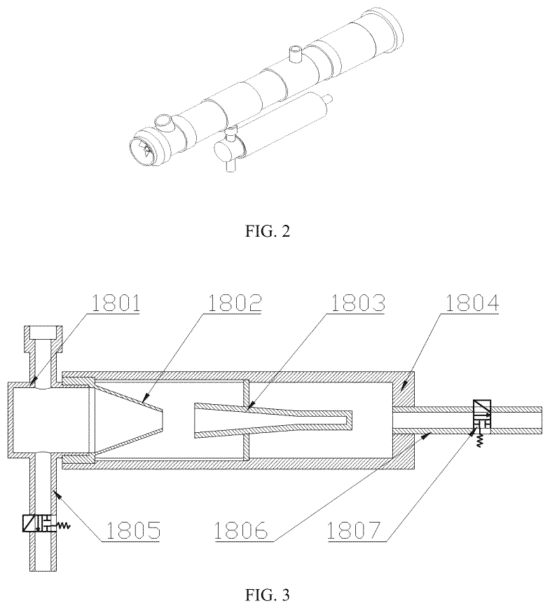

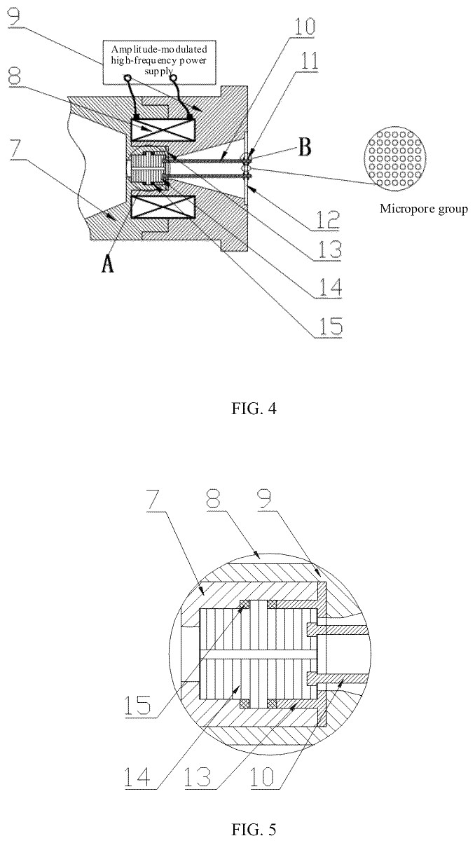

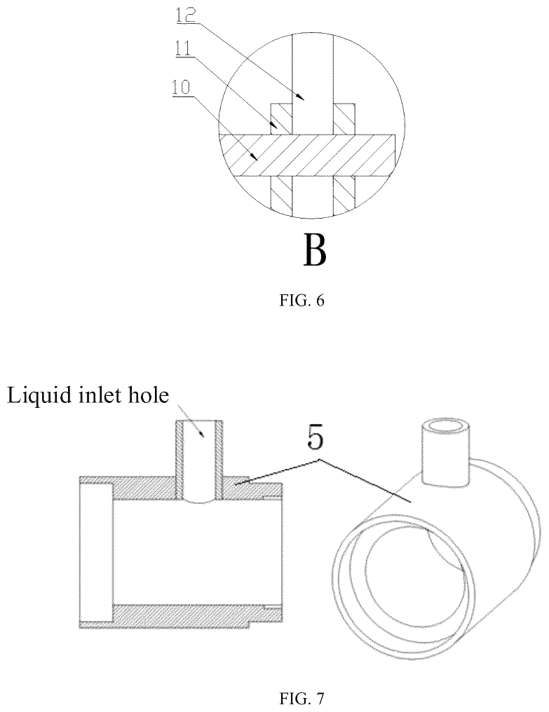

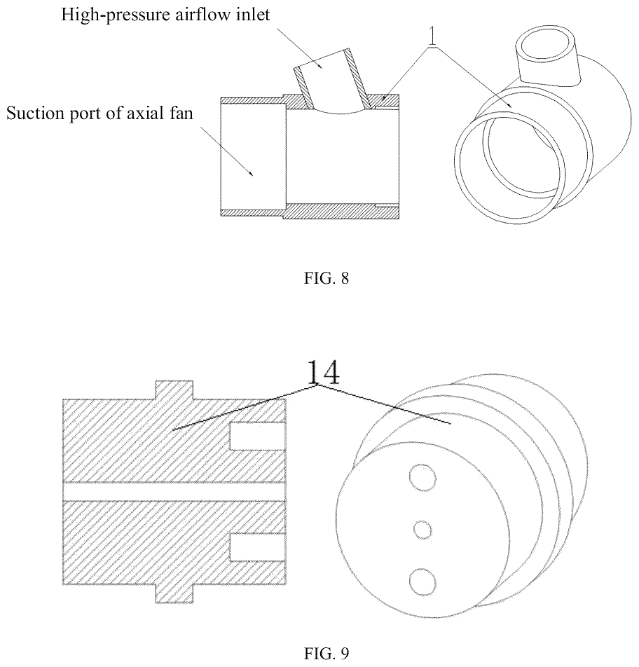

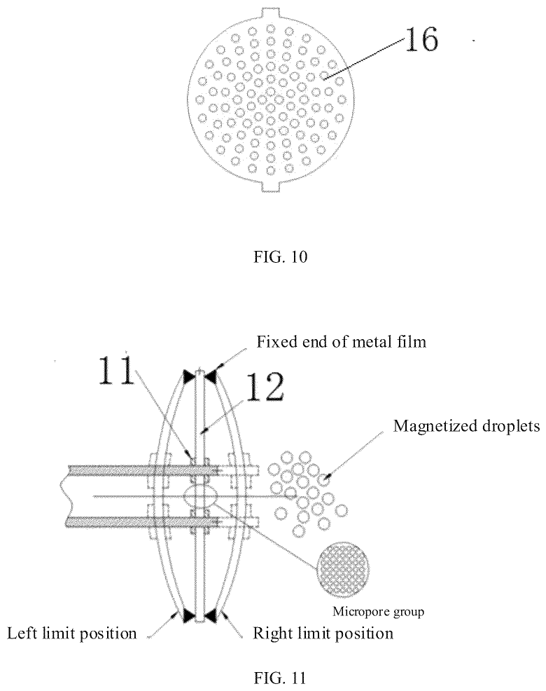

### REFERENCE NUMERALS

1—left axial flow section; 2—primary Laval tube; 3—Laval connecting section; 4—secondary Laval tube: 5—liquid inlet section; 6—right axial flow section; 7—droplet guide section; 8—excitation coil; 9—droplet discharge section; 10—connecting rod; 11—retaining device; 12—metal film; 13—oscillator stopper; 14—metal oscillator; 15—high temperature resistant elastic gasket; 16—charging electrode plate; 17—axial fan; 18—temperature-regulating device; 1801—temperature-regulating air guiding section; 1802—temperature-regulating air inlet section; 1803—conical resonant tube; 1804—temperature-regulating device housing; 1805—cold airflow pipe; 1806—hot airflow pipe; 1807—solenoid valve; 19—airway pipe; 20—airway pipe joint; 21—rotating shaft, 22—fixing frame; 23—deep groove ball bearing; 24—permanent magnet ring.

### DETAILED DESCRIPTION OF THE EMBODIMENTS

Embodiments of the present disclosure will be exemplarily described in detail hereinafter with reference to accompanying drawings in which the same or like reference characters refer to the same or like elements or elements having the same or like functions throughout. The embodiments described below with reference to accompanying drawings are exemplary, and intended to explain, instead of limiting the present disclosure.

In the description of the present disclosure, it should be understood that the orientation or positional relationships indicated by the terms “center”, “longitudinal”, “transverse”, “length”, “width”, “thickness”, “upper”, “lower”, “axial”, “radial”, “vertical”, “horizontal”, “inner”, “outer”, etc. are based on the orientation or positional relationships shown in the drawings, and are only for the convenience of describing the present disclosure and simplifying the description, rather than indicating or implying that the apparatus or element described must have a specific orientation or be constructed and operated in a specific orientation, and therefore are not to be construed as limiting the present disclosure. Moreover, the terms “first” and “second” are used herein for purposes of description, and are not intended to indicate or imply relative importance or implicitly point out the number of the indicated technical feature. Therefore, the features defined by “first” and “second” may explicitly or implicitly include one or more features. In the description of the present disclosure, “plural” means two or more, unless it is defined otherwise specifically.

In the present disclosure, unless otherwise clearly specified and defined, the terms “mount”, “connect”, “couple”, “fix” and variants thereof should be interpreted in a broad sense, for example, may be a fixed connection, a detachable connection, or an integral connection; may be a mechanical connection or an electrical connection; or may be a direct connection, an indirectly connection via an intermediate medium, or communication between the interiors of two components. For those of ordinary skill in the art, the specific meanings of the above terms in the present disclosure can be understood according to specific circumstances.

Provided is an air-assisted ultrasonic magnetization electrostatic nozzle, including a Laval tube, a liquid inlet section 5, a charging electrode plate 16, and a resonant cavity.

After being accelerated by the Laval tube, an air impacts a liquid that enters through the liquid inlet section 5 arranged at an outlet end of the Laval tube. The liquid is impacted into fine droplets, and the fine droplets are positively electrified after passing through the charging electrode plate 16 arranged at an outlet end of the liquid inlet section 5, to obtain electrified droplets. The electrified droplets enter the resonant cavity and are magnetized, to obtain magnetized droplets. The magnetized droplets are atomized and sprayed by a metal film 12 arranged at an outlet end of the resonant cavity.

In the above solution, a metal oscillator 14 is arranged in the resonant cavity; an excitation coil 8 surrounds an outer side of the metal oscillator 14; an oscillator stopper 13 is arranged on one side of the metal oscillator 14, one end of a connecting rod 10 is arranged on the oscillator stopper 13, and the other end of the connecting rod 10 is connected with a metal film 12; the excitation coil 8 is connected to an amplitude-modulated high-frequency power supply, and a vibration frequency of the metal oscillator 14 is adjustable by adjusting a current frequency of the amplitude-modulated high-frequency power supply; and the metal oscillator 14 drives the metal film 10 through the connecting rod 10 to vibrate at a high frequency.

In the above solution, the resonant cavity is a gradually expanding tube along a moving direction of the electrified droplets; and the metal oscillator 14 is supported and positioned by a high temperature resistant elastic gasket 15.

In the above solution, the metal film 12 is provided with a micropore group.

In the above solution, a plurality of through holes are uniformly arranged on the charging electrode plate 16.

In the above solution, axial fans 17 are arranged at an inlet end and the outlet end of the Laval tube, and permanent magnet rings 24 are arranged on an outer wall of the Laval tube and at positions corresponding to the axial fans 17; and one of the axial fans 17 which is arranged at the outlet end of the Laval tube is provided at a front end of the charging electrode plate 16, and the droplets are first crushed by the one of the axial fans 17 which is arranged at the outlet end of the Laval tube and then electrified by the charging electrode plate 16.

In the above solution, the two axial fans 17 are connected to a current integration module respectively through lead wires to form a closed loop, the rotating axial fans cuts magnetic induction lines to generate an induced current, and the current integration module rectifies and filters the induced current to supply power to the charging electrode plate 16 to electrify the droplets hitting the charging electrode plate 16.

In the above solution, the Laval tube includes a primary Laval tube 2 and a secondary Laval tube 4; a Laval tube connecting section 3 is arranged between the primary Laval tube 2 and the secondary Laval tube 4, the Laval tube connecting section 3 is provided with a through hole, one end of an airway pipe 19 is arranged in the Laval tube connecting section 3, the other end of the airway pipe 19 extends out of the Laval tube connecting section 3 and is sealedly communicated with a temperature-regulating air guiding section 1801, and the temperature-regulating air guiding section 1801 is configured to guide a part of an airflow from the primary Laval tube 2; the temperature-regulating air guiding section 1801 is a T-shaped three-way structure, and other two ends of the temperature-regulating air guiding section 1801 are respectively communicated with a temperature-regulating device housing 1804 and a cold airflow pipe 1805; the temperature-regulating device housing 1804 is configured to raise a temperature of the airflow to obtain a high-temperature airflow and discharge the high-temperature airflow to an aeroponic chamber to raise a temperature of the aeroponic chamber; and the cold airflow pipe 1805 discharges the airflow to a plant root environment of the aeroponic chamber.

In the above solution, a temperature-regulating air inlet section 1802 and a conical resonant tube 1803 are arranged in the temperature-regulating device housing 1804 in sequence, and a hot airflow pipe 1806 is arranged at an outlet of the temperature-regulating device housing 1804; the air enters the temperature-regulating air inlet section 1802 and the conical resonant tube 1803 through the temperature-regulating air guiding section 1801 and is heated, and is then discharged through the hot airflow pipe 1806; and both the temperature-regulating air guiding section 1801 and the temperature-regulating air inlet section 1802 are tapered pipes along an airflow direction.

In the above solution, the hot airflow pipe 1806 and the cold airflow pipe 1805 are each provided with a solenoid valve, and on and off of the solenoid valve are controlled by a control module according to a status of the aeroponic chamber.

### EXAMPLES

An air-assisted ultrasonic magnetization electrostatic nozzle includes a left axial flow section 1, a primary Laval tube 2, a Laval connecting section 3, a secondary Laval tube 4, a liquid inlet section 5, a right axial flow section 6, a droplet guide section 7, an excitation coil 8, a droplet discharge section 9, a connecting rod 10, a retaining device 11, a metal film 12, an oscillator stopper 13, a metal oscillator 14, a high temperature resistant elastic gasket 15, a charging electrode plate 16, an axial fan 17, a temperature-regulating device 18, an airway pipe 19, an airway pipe joint 20, a rotating shaft 21, a fixing frame 22, a deep groove ball bearing 23, a high-intensity permanent magnet ring 24, a current integration module, and a control module.

A shaft diameter of a left shell of the left axial flow section 1 is smaller than a shaft diameter of a right shell of the left axial flow section 1. An air inlet pipe is welded on the right shell to form a horizontal angle of 70° with a side wall of the right shell. The left axial flow section 1 is connected with one end of the primary Laval tube 2 through threads. The primary Laval tube 2 is connected with one end of the Laval connecting section 3 through threads. The Laval connecting section 3 is provided with a round hole in a direction perpendicular to a side wall thereof. The airway pipe joint 20 is connected with one end of the airway pipe 19 through threads. The secondary Laval tube 4 is connected with one end of the liquid inlet section 5 through threads. A hollow pipe is perpendicularly welded to a wall of the liquid inlet section 5. One axial fan 17 is mounted at each of two ends of the rotating shaft 19. The right axial flow section 6 is connected with the liquid inlet section 5 through threads. The charging electrode plate is mounted in a rectangular mounting groove at one end of the right axial flow section 6. The current integration module can provide functions of alternating current rectification, filtering, and voltage stabilization, and can store charges and feed charges into the charging electrode plate 16. The droplet guide section 7 is connected with the right axial flow section 6 through threads. The excitation coil 8 is nested at one end of the droplet discharge section 9. The droplet discharge section 9 is connected with the droplet guide section 7 through threads. The metal film 10 is fixed in a hole of the droplet discharge section 9 through welding. There are two high temperature resistant elastic gaskets 15, one of which is arranged between the metal oscillator 14 and the oscillator stopper 12, and the other is arranged between the metal oscillator 14 and the droplet guide section 7.

High-pressure air enters through an air compressor interface of the left axial flow section 1, and is accelerated to a supersonic speed through the primary Laval tube 2. At the Laval connecting section 3, the supersonic airflow is divided. One part of the airflow enters the temperature-regulating device 18 through the airway pipe joint 20. The other part of the airflow enters the secondary Laval tube 4 for secondary acceleration, and converges with a liquid flow in the liquid inlet section 5 for primary atomization.

The high-speed liquid flow drives the right axial fan 17 to rotate at a high speed and cut the magnetic induction lines. The induced current generated in the metal axial fan 17 is processed by the current integration module and then connected to the charging electrode plate 16 through a lead wire. After the primary atomization, the droplets hit the high-speed rotating axial fan 17 for secondary atomization. After the secondary atomization, the droplets hit the charging electrode plate 16 and lose negative charge and therefore are positively electrified. A surface of the charging electrode plate 16 is provided with densely and uniformly distributed through holes with the same aperture. When the charging electrode plate 16 is full of charges, the droplets hitting the electrode plate can be electrified. The direct-contact charging mode is adopted to uniformly electrify the droplets that hit the plate surface. In addition, the dense through holes on the charging electrode plate 16 can block the high-pressure liquid flow to prevent the flow rate of the liquid entering the magnetizing resonant cavity from being too high. The surface of the charging electrode plate 16 is provided with densely and uniformly distributed through holes with the same aperture. When the electrode plate is full of charges, the droplets hitting the electrode plate can be electrified. In addition, the dense through holes on the charging electrode plate 16 can block the high-pressure liquid flow to prevent the flow rate of the liquid entering the magnetizing resonant cavity from being too high. According to the electrostatic principle, the positively electrified droplets have increased adhesion to plants.

In the present disclosure, the current integration module can provide functions of alternating current rectification, filtering, and voltage stabilization, and can store charges and feed charges into the charging electrode plate 16. The excitation coil 8 is connected with the amplitude-modulated high-frequency power supply through a lead wire, and enameled wires of the coil are insulated to prevent short circuit due to current leakage The metal film 12 is connected with the metal oscillator 14 through the connecting rod 10 and the retaining device 11. The metal oscillator, when vibrating, also drives the metal film 12 to vibrate at a high frequency to discharge the droplets through the micropore group. The pore size of the micropore group on the metal film 12 is set to the nanometer level, and can be changed as required.

The temperature-regulating device 18 can divide the airflow entering the temperature-regulating device 18 through the airway pipe joint 18, and can release airflows with different temperatures from the cold airflow pipe 1805 and the hot airflow pipe 1806 respectively. The opening and closing of the two airflow pipes are controlled by the control module through the opening and closing of the solenoid valves 1807.

The excitation coil 8 is connected with the amplitude-modulated high-frequency power supply through a lead wire. An alternating magnetic field generated by the excitation coil 8 interacts with the induced current generated in the metal oscillator 14 to cause the metal oscillator 14 to vibrate at a high frequency. A vibration frequency of the metal oscillator 14 during operation can be adjusted by adjusting a current frequency of the amplitude-modulated high-frequency power supply connected with the excitation coil 8. After the secondary atomization, the electrified droplets enter the magnetizing resonant cavity, and hit the metal oscillator 14 for tertiary atomization. After the electrified droplets move in a direction perpendicular to the magnetic induction lines, the metal oscillator 14 drives the metal film 10 through the connecting rod 10 and the retaining device 11 to vibrate at a high frequency, so that the droplets further undergo quaternary atomization and ultra-fine droplets are discharged from the micropore group on the metal film 10, to obtain nanoscale magnetized droplets. In addition, the magnetized droplets can promote the growth of plants and improve the quality of crops.

Referring to FIG. 11, the metal film 12 moves or vibrates between the left limit position and the right limit position under the action of the connecting rod 10 and the metal oscillator 14, and the metal film 12 further atomizes the droplets hitting the metal film 12 during the movement or vibration.

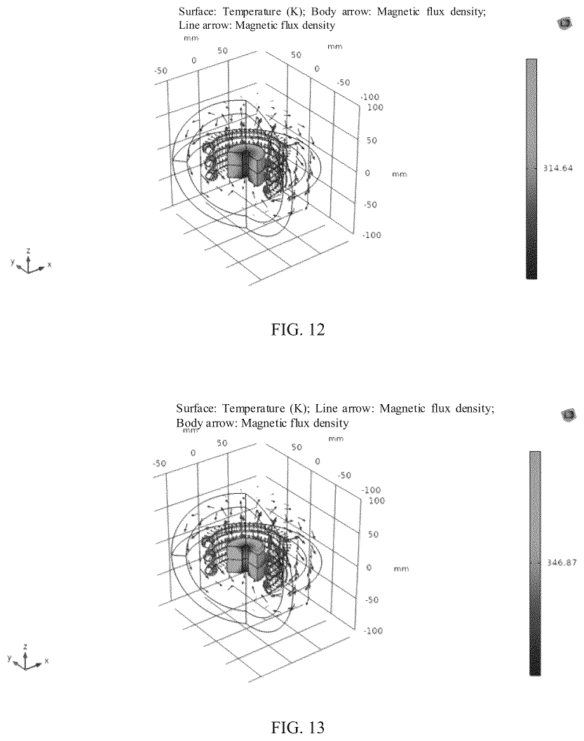

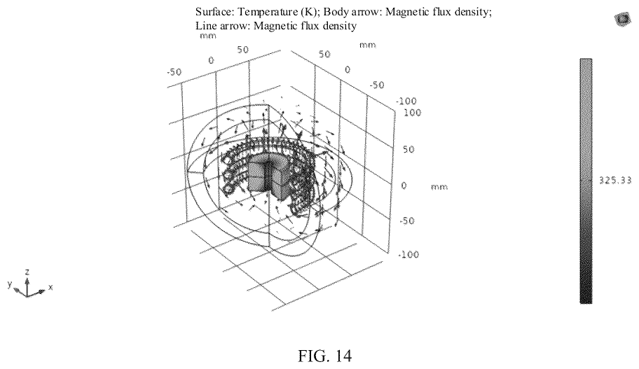

As shown in FIG. 12 to FIG. 14, to test the electromagnetic heating effect of several commonly used metal materials, COMSOL Multiphysics was used to simulate the metal oscillator with the same three-dimensional modeling parameters, using copper, structural steel, and aluminum alloy materials under the same working parameters. The simulation results show that the heating effect of the metal oscillator made of the copper material is lower.

The temperature-regulating device 18 includes the temperature-regulating device air guiding section 1801, the temperature-regulating air inlet section 1802, the conical resonant tube 1803, the temperature-regulating device housing 1804, the cold airflow pipe 1805, the hot airflow pipe 1806, and the solenoid valve 1807. The temperature-regulating air guiding section 1801 is provided with a lower welding hole and a lower welding hole opposite to each other in a 180° direction perpendicular to the tube wall. A hollow pipe welded to the upper tube wall hole on the temperature-regulating air guiding section 1801 is connected with the airway pipe 19 through threads. The cold airflow pipe 1805 is welded to the lower welding hole on temperature-regulating air guiding section 1801. The temperature-regulating air inlet section 1802 is connected with the temperature-regulating air guiding section 1801 through threads. The temperature-regulating device housing 1804 is connected with the temperature-regulating air inlet section 1802 through threads. The conical resonant tube 1803 is fixed in the temperature-regulating device housing 1804 through welding. The hot airflow pipe 1806 is connected with the temperature-regulating device housing 1804 through threads. One solenoid valve 1807 is mounted on each of the cold airflow pipe 1805 and the hot airflow pipe 1806.

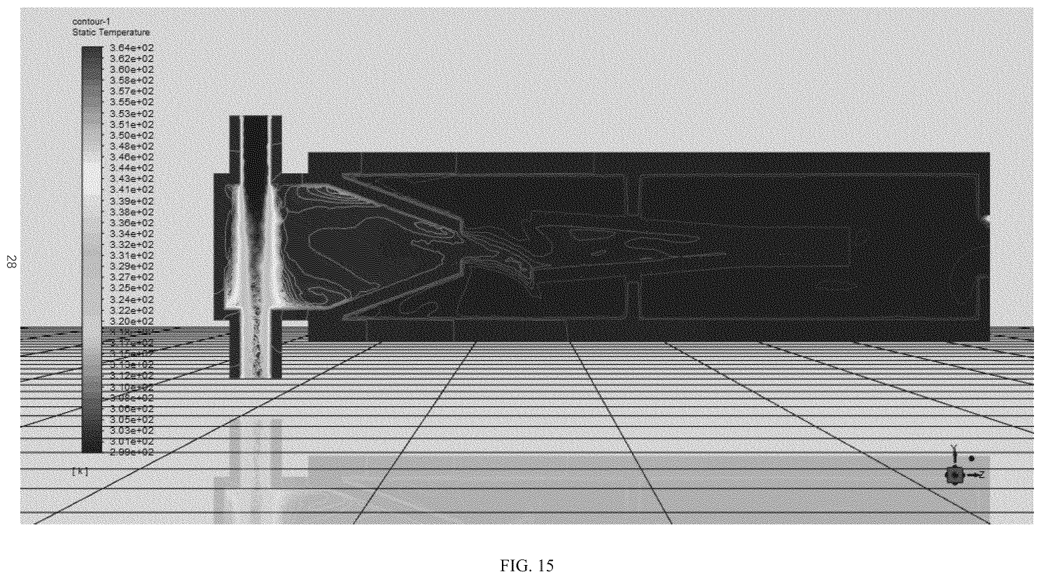

Referring to FIG. 15, the temperature-regulating effect of the temperature-regulating device is analyzed using simulation software ANSYS FLUENT. The result shows that the temperature at an outlet end of the cold airflow pipe differs greatly from that at an outlet end of the hot airflow pipe. Therefore, the control module can be used to control the opening and closing of the solenoid valves to realize the temperature-regulating function of the temperature-regulating device. When the ambient temperature decreases, the solenoid valve at the cold airflow pipe is closed and the solenoid valve at the hot airflow pipe is opened. When the ambient temperature rises, the solenoid valve 1807 at the cold airflow pipe 1805 is opened and the solenoid valve 1807 at the hot airflow pipe 1806 is closed. Therefore, the stress resistance of aeroponically propagated plants to the change of ambient temperature is improved. Specifically, when the temperature decreases, the cold airflow pipe is closed and the hot airflow pipe is opened, to increase the temperature of the aeroponic chamber and reduce the impact of temperature drop on the rhizosphere temperature. When the air temperature rises, the cold airflow pipe is opened and the hot airflow pipe is opened, to lower the temperature of the aeroponic chamber and reduce the impact of temperature rise on the root system.

The operation process of the air-assisted ultrasonic magnetization electrostatic nozzle is as follows.

High-pressure air enters through the air compressor interface of the left axial flow section 1, and is accelerated to a supersonic speed through the primary Laval tube 2. At the Laval connecting section 3, the supersonic airflow is divided. One part of the airflow enters the temperature-regulating device through the airway pipe joint 20. The other part of the airflow enters the secondary Laval tube 4 for secondary acceleration, and converges with a liquid flow in the liquid inlet section 5 for primary atomization. The high-speed liquid flow drives the right axial fan 17 to rotate at a high speed and cut the magnetic induction lines. The induced current generated in the metal axial fan 17 is processed by the current integration module and then connected to the charging electrode plate 16 through a lead wire. After the primary atomization, the droplets hit the high-speed rotating axial fan 17 for secondary atomization. After the secondary atomization, the droplets hit the charging electrode plate 16 and lose negative charge and therefore are positively electrified. The excitation coil 8 is connected to the amplitude-modulated high-frequency power supply through a lead wire. The alternating magnetic field generated by the excitation coil 8 interacts with the induced current generated in the metal oscillator 14 to cause the metal oscillator 14 to vibrate at a high frequency. After the secondary atomization, the electrified droplets enter the magnetizing resonant cavity, and hit the metal oscillator 14 for tertiary atomization. After the electrified droplets move in the direction perpendicular to the magnetic induction lines, the metal oscillator 14 drives the metal film 12 through the connecting rod 10 to vibrate at a high frequency, so that the droplets further undergo quaternary atomization and are discharged from the micropore group on the metal film, to obtain nanoscale magnetized droplets.

In the description of the specification, the description with reference to the terms “an embodiment”, “some embodiments”, “example”, “specific example”, or “some example” and so on means that specific features, structures, materials or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials or characteristics may be combined in any suitable manner in one or more embodiments.

Although the embodiments of the present disclosure have been illustrated and described above, it is to be understood that the above embodiments are exemplary and not to be construed as limiting the present disclosure, and that changes, modifications, substitutions and alterations can be made by those skilled in the art without departing from the scope of the present disclosure.

1. An air-assisted ultrasonic magnetization electrostatic nozzle, comprising a Laval tube, a liquid inlet section (5), a charging electrode plate (16), and a resonant cavity, wherein after being accelerated by the Laval tube, an air impacts a liquid that enters through the liquid inlet section (5) arranged at an outlet end of the Laval tube; the liquid is impacted into fine droplets, and the fine droplets are positively electrified after passing through the charging electrode plate (16) arranged at an outlet end of the liquid inlet section (5), to obtain electrified droplets; the electrified droplets enter the resonant cavity and are magnetized, to obtain magnetized droplets; the magnetized droplets are atomized and sprayed out by a metal film (12) arranged at an outlet end of the resonant cavity; a metal oscillator (14) is arranged in the resonant cavity; an excitation coil (8) surrounds an outer side of the metal oscillator (14); an oscillator stopper (13) is arranged on one side of the metal oscillator (14); one end of a connecting rod (10) is arranged on the oscillator stopper (13), and an other end of the connecting rod (10) is connected with the metal film (12); the excitation coil (8) is connected to an amplitude-modulated high-frequency power supply, and a vibration frequency of the metal oscillator (14) is adjustable by adjusting a current frequency of the amplitude-modulated high-frequency power supply; and the metal oscillator (14) drives the metal film (12) through the connecting rod (10) to vibrate at a high frequency.

2. The air-assisted ultrasonic magnetization electrostatic nozzle according to claim 1, characterized in that, the resonant cavity is a gradually expanding tube along a moving direction of the electrified droplets; and the metal oscillator (14) is supported and positioned by a high temperature resistant elastic gasket (15).

3. The air-assisted ultrasonic magnetization electrostatic nozzle according to claim 1, characterized in that, the metal film (12) is provided with a micropore group.

4. The air-assisted ultrasonic magnetization electrostatic nozzle according to claim 1, characterized in that, a plurality of through holes are uniformly arranged on the charging electrode plate (16).

5. The air-assisted ultrasonic magnetization electrostatic nozzle according to claim 1, characterized in that, axial fans (17) are respectively arranged at an inlet end and the outlet end of the Laval tube, and permanent magnet rings (24) are arranged on an outer wall of the Laval tube and at positions corresponding to the axial fans (17); and one of the axial fans (17) which is arranged at the outlet end of the Laval tube is provided at a front end of the charging electrode plate (16), and the droplets are first crushed by the one of the axial fans (17) which is arranged at the outlet end of the Laval tube and then electrified by the charging electrode plate (16).

6. The air-assisted ultrasonic magnetization electrostatic nozzle according to claim 5, characterized in that, the two axial fans (17) are connected to a current integration module respectively through lead wires to form a closed loop, the rotating axial fans cut magnetic induction lines to generate an induced current, and the current integration module rectifies and filters the induced current to supply power to the charging electrode plate (16), to electrify the droplets hitting the charging electrode plate (16).

7. The air-assisted ultrasonic magnetization electrostatic nozzle according to claim 1, characterized in that, the Laval tube comprises a primary Laval tube (2) and a secondary Laval tube (4); a Laval tube connecting section (3) is arranged between the primary Laval tube (2) and the secondary Laval tube (4), the Laval tube connecting section (3) is provided with a through hole, one end of an airway pipe (19) is arranged in the Laval tube connecting section (3), an other end of the airway pipe (19) extends out of the Laval tube connecting section (3) and is sealedly communicated with a temperature-regulating air guiding section (1801), and the temperature-regulating air guiding section (1801) is configured to guide a part of an airflow from the primary Laval tube (2); the temperature-regulating air guiding section (1801) is a T-shaped three-way structure, and other two ends of the temperature-regulating air guiding section (1801) are respectively communicated with a temperature-regulating device housing (1804) and a cold airflow pipe (1805), the temperature-regulating device housing (1804) is configured to raise a temperature of the airflow to obtain a high-temperature airflow and discharge the high-temperature airflow to an aeroponic chamber to raise a temperature of the aeroponic chamber; and the cold airflow pipe (1805) discharges the airflow to a plant root environment of the aeroponic chamber.

8. The air-assisted ultrasonic magnetization electrostatic nozzle according to claim 7, characterized in that, a temperature-regulating air inlet section (1802) and a conical resonant tube (1803) are arranged in the temperature-regulating device housing (1804) in sequence, and a hot airflow pipe (1806) is arranged at an outlet of the temperature-regulating device housing (1804); the air enters the temperature-regulating air inlet section (1802) and the conical resonant tube (1803) through the temperature-regulating air guiding section (1801) and is heated, and is then discharged through the hot airflow pipe (1806); and both the temperature-regulating air guiding section (1801) and the temperature-regulating air inlet section (1802) are tapered pipes along an airflow direction.

9. The air-assisted ultrasonic magnetization electrostatic nozzle according to claim 8, characterized in that, the hot airflow pipe (1806) and the cold airflow pipe (1805) are each provided with a solenoid valve, and on and off of the solenoid valve are controlled by a control module according to a status of the aeroponic chamber.
